(19) United States
(12) Patent Application Publication
(10) Pub. No.: US 2024/0070125 A1
(43) Pub. Date: Feb. 29, 2024

(54) Data Management in a Network Function

(71) Applicant: TELEFONAKTIEBOLAGET LM ERICSSON (PUBL), Stockholm (SE)

(72) Inventors: Arvindh Rajesh Tamilmani, Chennai (IN); JayaKrishnan Kizhakke Pullarappillil, Cochin (IN); Settipalli Narasimham, Chennai (IN); Nagarajan M, Chennai (IN); Karthikeyan Chandrasekar, Chennai (IN)

(21) Appl. No.: 18/547,517

(22) PCT Filed: Mar. 19, 2021
(86) PCT No.: PCT/IN2021/050287

§ 371 Date: Aug. 23, 2023

(51) Int. Cl. G06F 16/21

(52) U.S. Cl. CPC G06F 16/211

(57) ABSTRACT

In an example, a method in a first network function of sending data to a second network function is provided. The data comprises at least one data portion. The method comprises including in the data, for each of at least one of the at least one data portion, an indication of 5 a data management category for the data portion, and sending the data to the second network function.

### TECHNICAL FIELD

Examples of the present disclosure relate to data management of data. For example, including an indication of a data management category for a data portion in data sent to a network function, or data management in a network function.

### BACKGROUND

As more and more systems and individuals become connected via communication technology, the privacy of individuals and their information becomes important. While personally identifiable information (such as MSISDN) and other sensitive personal information (such as location and call data) may be required to enable the communication technology, there is the risk of identity theft or other misuses of personal information.

Some communication systems use Service Based Architecture (SBA). One example is the 5G communication system. The 5G System Architecture uses SBA between Network Functions (NFs) to provide communication services. Network Functions provide services to other authorized Network Functions to achieve system functionalities via service-based interfaces (SBIs). Each Network Function offers different functionalities and thereby provides different services.

Communication system specifications, such as for example 3GPP specifications, may recommend or mandate end-to-end authentication and encryption, whereby for example an entire set of data sent between two network functions may be encrypted. However, this may not prevent unwanted storage or forwarding of private or sensitive information by the sending or receiving network function. This also does not encompass data minimization, such as for example which information should or should not be forwarded, and data retention, such as for example which information to store in log files or databases.

### SUMMARY

One aspect of the present disclosure provides a method in a first network function of sending data to a second network function. The data comprises at least one data portion. The method comprises including in the data, for each of at least one of the at least one data portion, an indication of a data management category for the data portion, and sending the data to the second network function.

Another aspect of the present disclosure provides a method of data management in a second network function. The method comprises receiving data from a first network function, the data comprising at least one data portion and, for each of at least one of the at least one data portion, an indication of a data management category for the data portion, and for each data portion, performing data management in accordance with the data management category of the data portion.

A further aspect of the present disclosure provides a method in a repository network function. The method comprises receiving, from a first network function, a request for a respective data management category of at least one data portion in data, and sending an indication of the respective data management category of the at least one data portion to the first network function.

A still further aspect of the present disclosure provides apparatus for sending data to a second network function. The data comprises at least one data portion. The apparatus comprises a processor and a memory. The memory contains instructions executable by the processor such that the apparatus is operable to implement a first network function and include in the data, for each of at least one of the at least one data portion, an indication of a data management category for the data portion, and send the data to the second network function.

An additional aspect of the present disclosure provides apparatus for data management by a second network function. The apparatus comprises a processor and a memory. The memory contains instructions executable by the processor such that the apparatus is operable to receive data from a first network function, the data comprising at least one data portion and, for each of at least one of the at least one data portion, an indication of a data management category for the data portion, and for each data portion, perform data management in accordance with the data management category of the data portion.

Another aspect of the present disclosure provides apparatus comprising a processor and a memory. The memory contains instructions executable by the processor such that the apparatus is operable to implement a network repository function and receive, from a first network function, a request for a respective data management category of at least one data portion in data, and send an indication of the respective data management category of the at least one data portion to the first network function.

An additional aspect of the present disclosure provides apparatus for sending data to a second network function. The data comprises at least one data portion. The apparatus is configured to implement a first network function and include in the data, for each of at least one of the at least one data portion, an indication of a data management category for the data portion, and send the data to the second network function.

A further aspect of the present disclosure provides apparatus for data management by a second network function. The apparatus is configured to receive data from a first network function, the data comprising at least one data portion and, for each of at least one of the at least one data portion, an indication of a data management category for the data portion, and for each data portion, perform data management in accordance with the data management category of the data portion.

Another aspect of the present disclosure provides apparatus configured to implement a network repository function and receive, from a first network function, a request for a respective data management category of at least one data portion in data, and send an indication of the respective data management category of the at least one data portion to the first network function.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is flow chart of an example of a method in a first network function of sending data to a second network function;

FIG. 2 shows an example of a JavaScript Object Notation (JSON) schema;

FIG. 3 shows an example of a JSON data structure;

FIG. 4 shows another example of a JSON data structure;

FIG. 5 is a flow chart of an example of a method of data management in a second network function;

FIG. 6 is a flow chart of an example of a method in a repository network function;

FIG. 7 shows an example of communications within a network

FIG. 8 is a schematic of an example of apparatus for sending data to a second network function;

FIG. 9 is a schematic of an example of apparatus for data management by a second network function; and

FIG. 10 is a schematic of an example of apparatus according to embodiments of this disclosure.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general-purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Information and parameters may be exchanged between Network Functions (NFs) in a communication system using Information Elements (IEs), for example in JavaScript Object Notation (JSON) format. These IEs may also contain private or sensitive information such as for example a user's phone number, location, vendor specific extensions and other information. The sensitivity of these IEs and the information they contain, and how they should be handled by intermediate network functions, is not covered in communication system specifications. Since handling of private or sensitive information is becoming important, there is a need for managing data such as for example sensitive or private information in a communication system. Examples of communication systems include the 4G and 5G communication systems.

As stated above, communication system specifications, such as for example 3GPP specifications, may recommend or mandate end-to-end authentication and encryption, whereby for example an entire set of data sent between two network functions may be encrypted. However, this may not prevent unwanted storage or forwarding of private or sensitive information by the sending or receiving network function. This also does not encompass data minimization, such as for example which information should or should not be forwarded, and data retention, such as for example which information to store in log files or databases.

It is not practical for each network function (or other sub-component of a communication network) to have a list of specific privacy-sensitive IEs configured. The addition of a new IE or other piece of information that may be communicated between NFs would require software updates at multiple places in the network and also at each network function.

Example embodiments of this disclosure provide a system for specifying a data management category (such as for example a privacy or sensitivity level) for different data portions of a set of data. In such a system, for example, a data portion that is in a category that indicates the data portion is privacy-sensitive at the originating Network Function may be automatically handled during data transit, data minimization and data retention in subsequent Network Functions. In some examples, categories for data portions and how the data in them is handled may be specific to a particular country, territory or network, so in certain situations such as roaming scenarios data may be handled appropriately.

In some examples, for data portions in data, a data management category may be introduced, via for example an attribute, to indicate a data management category for the data portion. For example, the data management category may indicate the way the data in the data portion should be managed or handled, and actions that may or may not be performed on that data portion. For example, the category of the data portion may indicate that the data portion is privacy sensitive, and may thus impact on the way the data portion is logged or stored at a network function and whether and in what manner it may be forwarded to other network functions.

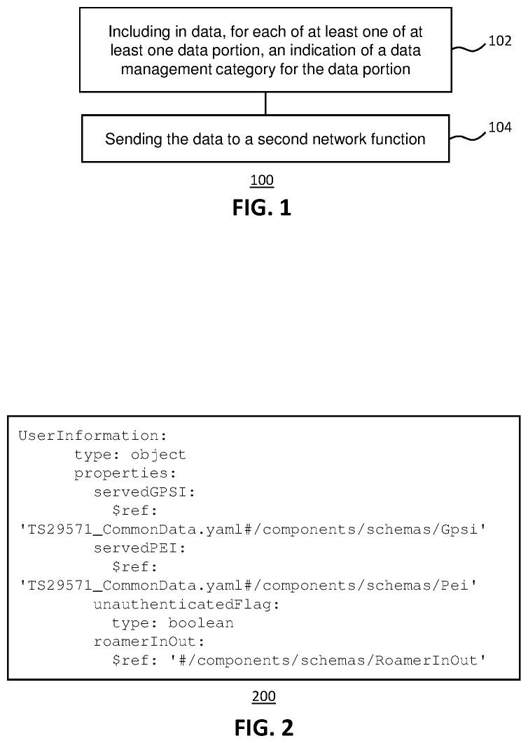

FIG. 1 is a flow chart of an example of a method 100 in a first network function of sending data to a second network function. The data may be in a suitable format, such as for example JSON format in some examples. The data comprises at least one data portion. In some examples, a data portion may be an information element (IE). Thus, the data may comprise one or more IEs. In other examples, a data portion may comprise part of an information element, or multiple information elements. The data portion may also in some examples comprise one or more JSON objects, arrays, properties and/or key-value pairs.

The method 100 comprises, in step 102, including in the data, for each of at least one of the at least one data portion, an indication of a data management category (e.g. one of a plurality of data management categories) for the data portion. This may be done in a number of suitable ways. For example, the indication of the data management category may be a key-value pair in an object such as a JSON object. This disclosure is not limited to any particular representation of a data object or the indication of a data management category for a data object. Step 104 of the method 100 comprises sending the data to the second network function. The data sent to the second NF includes the indication(s) of the data management category of each data portion. In some examples, the data may comprise multiple data portions, and one, some or all of the data portions may have a data management category that is indicated by a respective indication.

In some examples, the indication of a data management category for a data portion indicates one or more data management actions for the data portion by the second network function. That is, actions that may be taken by the second network function in respect of the data portion or the information contained therein. In an example, the actions for a data portion by the second network function comprise whether or not to store the data portion. Storage of a data portion may occur for example during logging of data and information sent to or passing through the second network function. In another example, the data management actions may include whether or not to forward the data portion to a third network function, anonymize the data portion and/or encrypt the data portion. Additionally or alternatively, the actions may comprise performing any other operation or action on the data portion,

Anonymization of the data portion may comprise for example generalising certain terms into one of a plurality of ranges. As an example, if a data portion indicated an age of a user of a UE, then the age may be generalized into one of a plurality of ranges such as 0-20, 21-30, 31-40, 41-50 and so on. Therefore, if a user has an age of 34, then the information may be generalized as simply an unspecified age in the range 31-40. This is merely an example and other examples of anonymization or generalization of any type of information are also possible. Encryption of a data portion may in some examples ensure that any intermediate nodes or network functions (which may include the second network function) between the first network function and the destination of the data (e.g. a NF service consumer) are unable to understand the information in the data portion.

The indication of a data management category for a data portion may comprise for example an indication of a privacy or sensitivity level of the data portion. The actions to be taken in respect of the data portion by the second network function may thus for example depend on the privacy or sensitivity level. In some examples, the method 100 may comprise receiving the data from another network function, and wherein sending the data to the second network function comprises forwarding at least some of the data to the second network function. The received data may include the indication(s) of data management category for each data portion. The first network function may thus for example refraining from forwarding to the second network function at least one data portion for which the privacy or sensitivity level is above a predetermined level, and forward other data portions. The first NF may additionally or alternatively in some examples anonymize at least one data portion for which the privacy or sensitivity level is above a predetermined level, and/or encrypting at least one data portion for which the privacy or sensitivity level is above a predetermined level, before sending to the second NF. Similarly, the first network function may for example add at least some of the data to a data log or database, and refrain from adding to the data log or database at least one data portion for which the privacy or sensitivity level is above a predetermined level. By providing an indication of the data management category for each data portion sent to the second NF, the second NF may in some examples perform similar actions, or in any case the first NF will be able to inform the second NF (via the data management categories) which actions to take, even if these actions are not taken by the first NF itself (e.g. if it is the originator of the data or the information therein).

In some examples, at least one data portion comprises a vendor-specific data portion that is proprietary to a vendor of the another network function or a producer of the data. In such examples, the data management category (and hence actions) for the vendor-specific data portion may be indicated in the data, and thus an intermediate NF (between the sender and ultimate recipient of the data, which may in some examples include the first NF and/or the second NF) will in some examples be able to determine what data management actions to take in respect of the vendor-specific data portion, even if the intermediate NF is otherwise unaware of or does not expect the data portion or the information it contains (e.g. if the data portion is not defined in a schema or 3GPP standard). In some examples, the producer or sender of the data may be a NF service provider, and the recipient or ultimate destination may be a NF service consumer, or the producer or sender may alternatively be a NF service consumer.

In some examples, the first network function may receive an indication of the one or more data management actions for each category from a repository network function, such as a Network Repository Function (NRF). The repository NF may thus for example operate as a centralized repository in a network that maintains lists of data management categories and the respective data management actions associated therewith. Any network function may therefore for example query the repository NF, and receive from the repository NF an indication of actions that should be taken for received data portions with particular data management categories.

The method 100 may in some examples comprise sending an indication of the one or more data management actions for each category to a repository network function. Thus in some examples the first NF may inform the repository NF of the actions that should be taken in respect of a data portion of a particular category. The first NF may also keep the repository NF informed of any changes or updates to the actions to be performed for a particular data management category. Thus, for example, the method 100 may comprise determining one or more updated data management actions for at least one category, and sending an indication of the one or more updated data management actions to the repository network function.

In some examples, where a repository NF stores data management categories and their associated actions, other NFs may register for updates to these. So, for example, where the repository NF receives updates to the data management categories or the associated actions, these may be automatically sent to the registered NFs to keep them updated.

In a particular example, a Charging Function (CHF) network function may indicate to the repository NF that a permanent equipment identifier (PEI) and user location information should be tagged as high privacy or sensitivity. When a Session Management Function (SMF) wants to initiate a CHF Create request towards CHF, it shall request and receive information from the repository NF for categorization of data portions, including for example the PEI and user location information, and accordingly includes indications of categories for at least these data portions in the data.

In another example, the repository NF may notify data management categories to a NF producer or consumer based on their subscription upon updates to the categories or associated actions. For example, a SMF may want to initiate a CHF Create, Update or Terminate scenario towards a CHF for 5G converged charging. In some examples, the repository NF may know that the SMF is a NF consumer and the CHF is a NF producer for converged charging functionality in this scenario. Therefore, the repository NF may notify the SMF with CHF data management categories (i.e. the ones provided by the CHF) based on the SMF's subscription to such information.

In some examples, the first NF may receive an indication of the respective category of at least one data portion from a repository network function such as a NRF. Thus the first NF may determine which category to apply to a particular data portion (and hence which indication) in this manner. Alternatively, for example, the first NF may send an indication of the respective category for at least one data portion to a repository network function, for example to be stored by the repository NF and provided to other NFs if desired. In some examples, the first NF may determine one or more updated categories for at least one data portion, and sending an indication of the one or more updated categories for at least one data portion to the repository network function. Thus the repository NF may store the latest category for a particular data portion.

In some examples, the data sent to the second NF comprises a data structure defined by a data structure schema. A schema defines what data should appear in the data structure and how it should be organized. FIG. 2 shows an example of a JSON schema 200. The schema 200 in this example indicates that a JSON data structure that complies with the schema 200 may include one object (called UserInformation) that has information elements (or key-value pairs) called servedGPSI, servedPEI, unauthenticatedFlag and roamerInOut. A JSON data structure may in some examples have additional IEs, key-value pairs or other information that is not specified in the schema.

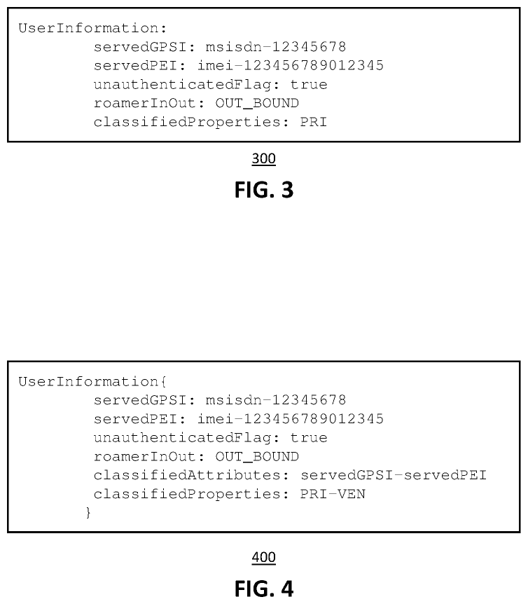

FIG. 3 shows an example of a JSON data structure 300. The data structure 300 includes one object called UserInformation and includes the four key-value pairs specified in the example schema 200. Thus, the data structure 300 complies with the schema 200. The UserInformation object also includes an additional key-value pair, called classifiedProperties and with the value PRI. This key-value pair is an example of an indication of a data management category for a data portion, where the data portion in this example is the object called UserInformation. This indicates that the UserInformation object has the data management category value of PRI, and thus for example any data management actions to be taken in respect of the data portion should be in accordance with the category PRI. In one example, the category PRI may be a high privacy category and the data management actions are associated with high privacy or sensitivity information.

In the example shown in FIG. 3, the whole UserInformation object is associated with the indicated data management category. However, in other examples, the category may apply to other portions of data within a data structure. FIG. 4 is another example of a JSON data structure 400 that complies with the schema 200 shown in FIG. 2. The data structure 400 includes a UserInformation object, with the key-value pairs classifiedAttributes and classifiedProperties. The classifiedAttributes key-value pair indicates the key-value pairs to which a data management category applies, and the classifiedProperties key-value pair indicates the data management category. In this example shown in FIG. 4, the classifiedAttributes key-value pair is a hyphen separated list with the value servedGPSI-servedPEI, and hence the category applies to the servedGPSI and servedPEI key-value pairs. The classifiedProperties key-value pair indicates the category is PRI-VEN. Hence, a particular data management category can apply to any suitable part of a data structure such as a JSON data structure, though in other examples other ways of indicating the data management category may be used. Additionally, in other examples, the data (and any associated schema, if any) may take another format other than JSON.

In some examples, the indication of the data management category for the data portion is not defined in the schema. This is the case for the JSON data structure 300 shown in FIG. 3, where the classifiedProperties key-value pair is not defined in the JSON schema 200. This may for example allow the classifiedProperties (or other indication of the data management category) to be omitted in some cases, for example where the network function or other network node sending the data does not know the category or does not know that a category should be applied for a data object. For example, the indication may be additionalproperties, which is may be feature provided by a JSON schema in some examples to dynamically add properties to a JSON object without having the property declared in a JSON schema.

In some examples, the first network function may be for example a Session Management Function (SMF), Charging Function (CHF), Policy Control Function (PCF) or Access and Mobility Management Function (AMF). Similarly, the second network function may be for example a Session Management Function (SMF), Charging Function (CHF), Policy Control Function (PCF) or Access and Mobility Management Function (AMF). These are merely examples and the first and/or second NF may be a different type of NF in other examples.

In some particular examples, a data portion may be Information Element, and its data management category may be dynamically added as part of a representational state transfer (REST) message exchanged between a NF Service Consumer and a NF Service Producer. In some examples, the first NF may be the NF service producer, and/or the second NF may be the NF service consumer, or vice versa. The particular data management category for a data object and thus the information contained therein may in some examples be guided by the operator network, or by Government and country regulations from where the data is initiated (e.g, at the first NF or a NF service producer or consumer).

In some examples, a repository NF may determine different data management categories for different scenarios. For example, the NF may determine (e.g. from a NF that is requeting data management category information) whether data relates to a non-roaming or roaming scenario and may provide different category information depending on the scenario. Alternatively, for example, the repository NF may provide information for multiple scenarios and the requesting NF may use the categories for the appropriate scenario.

In an example roaming scenario, local breakout functionality may be used to connect a Home CHF with Visiting SMF through Security Edge Protection Proxy (SEPP). The Visiting SEPP (vSEPP) in VPLMN network connects to HPLMN SEPP, and the HPLMN UDM, UDR and CHF can be accessed using service-based architecture (SBA) service framework. In this example roaming scenario, the visiting SMF connects to HPLMN SMF and then to CHF. UDM/UDR network functions are placed in HPLMN network where home subscriber information can be fetched. UDM stores the data management categories. When a roaming scenario is detected, a subscriber profile is fetched from UDM to PCF and then passed to SMF. The SMF uses this category information to construct converged charging messages including indications of the appropriate data portions.

In a local breakout scenario, SMF and CHF in HPLMN network use UDM profile within the HPLMN network when a session is routed from VPLMN SMF to HPLMN SMF. PCF detects that converged charging PCC rules shall be applied. In turn the PCF retrieves the data management categories from a UDM profile which might be stored in UDR in subscription data. vSMF may use the data management categories for example in Nchf_ConvergedCharging Create, Nchf_ConvergedCharging Update, Nchf_ConvergedCharging Delete service operations, e/g. in JSON messages.

Data management categories may be used in some examples where data is communicated between different networks. For example, the different networks may be 5G networks with different operators, multiple operator core network (MOCN) or MVNO networks. A MVNO network uses radio spectrum shared from mainstream MNO operator networks. In this scenario, MVNO operator has their own SMF, PCF, CHF, UDM/UDR and NRI network functions. Both in home or roaming networks, data management categories can be used to avoid intermediate gateways opening full packets and may be used to ensure secure communication.

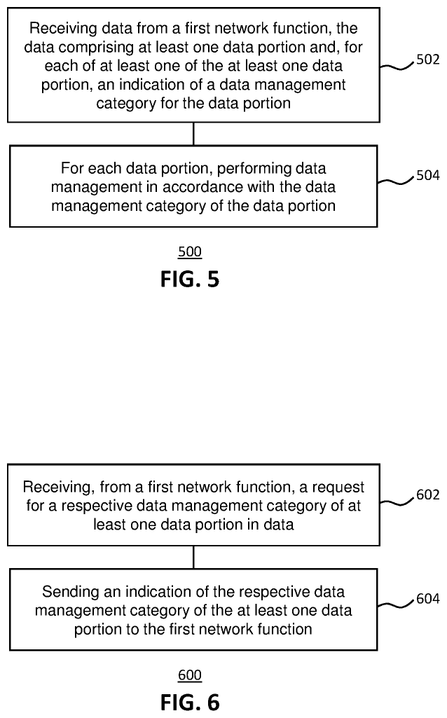

FIG. 5 is a flow chart of an example of a method 500 of data management in a second network function. In some examples, the second network function is the second network function referred to above in respect of the method 100 shown in FIG. 1. The method 500 comprises, in step 502, receiving data from a first network function, the data comprising at least one data portion and, for each of at least one of the at least one data portion, an indication of a data management category for the data portion. The method 500 also comprises, in step 504, for each data portion, performing data management in accordance with the data management category of the data portion. Any variations and examples referred to above with respect to the method 100 shown in FIG. 1 may also be applied to the method 500 where appropriate. Thus for example the second network function may perform any appropriate actions in respect of a data portion, such as actions in relation to forwarding, encryption and/or storage, and may for example retrieve the actions to perform in respect of a particular category or data portion from a repository NF, and the data and indication(s) may be provided in any suitable format such as JSON.

FIG. 6 is a flow chart of an example of a method 600 in a repository network function such as a NRF. The method comprises, in step 602, receiving, from a first network function, a request for a respective data management category of at least one data portion in data. In some examples, the data may be data received by the first network function. Additionally or alternatively, the data may be data that may be partially or fully forwarded to a different network function. Step 604 of the method 600 comprises sending an indication of the respective data management category of the at least one data portion to the first network function.

Thus for example the first network function (which may be for example the first or second NF referred to in respect of the methods 100 and 500 described above) may be informed of the data management category of data portion(s) in data, and hence may for example perform appropriate data management actions, e.g. in respect of anonymization, encryption and/or storage. Any variations and examples referred to above with respect to the method 100 or 500 may also be applied to the method 600 where appropriate. Thus for example the first network function may perform any appropriate actions in respect of a data portion, such as actions in relation to forwarding, encryption and/or storage, and the data and indication(s) may be provided in any suitable format such as JSON.

In some examples, the indication of a data management category for a data portion indicates one or more data management actions for the data portion, such as for example whether or not to store the data portion and/or whether or not to forward the data portion to a second network function.

An indication of the one or more data management actions for each category may in some examples be received from the first network function or another network function, and hence in some examples the repository NF may store and maintain a list of the actions (and any updates) for each category. Similarly, the repository NF may in some examples store and maintain a list of data management category (and any updates) for each data portion.

Advantages provided by embodiments of this disclosure may include a simple manner for communicating data management categories for data and enforcement of data management actions such as privacy requirements. However, privacy and sensitivity are only examples of types of category, and information regarding other category types may be conveyed in a similar manner. Additionally, example embodiments may allow for fine control of data management categories for data, such as for example at an individual IE level. There may in some examples also be no need for a list of data portions and their data management categories and actions to be maintained at each NF.

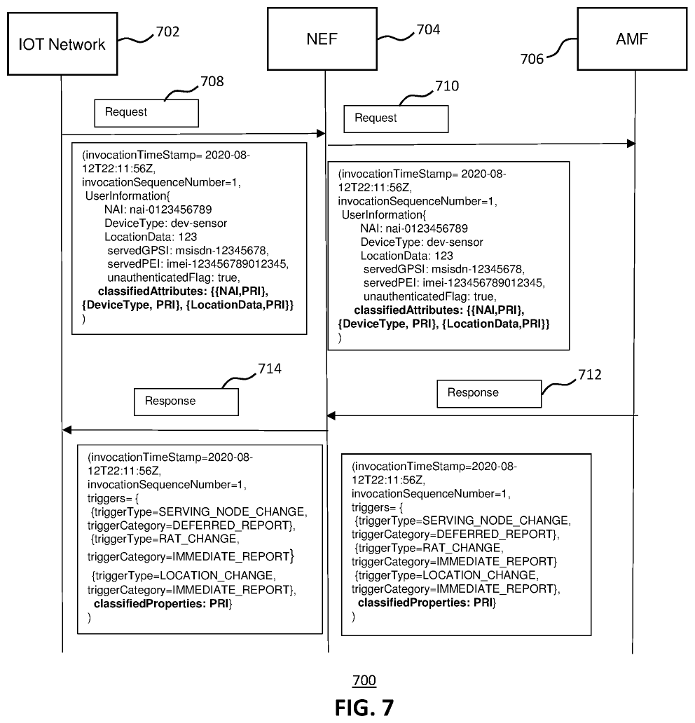

In an example of a 5G communication network, it is possible to attach Internet of Things (IoT) devices to the network in specific low- and mid-bands to handle Narrowband-IoT (NB-IoT) and enhanced machine-type communications (eMTC) services. FIG. 7 shows an example of communications within a network 700. In order to configure IoT devices or send specific machine critical information to IoT devices from the 5G network, a Network Exposure Function (NEF) 704 can be connected to an IoT enterprise network 702. The NEF may send data from the IoT network 702 that includes indications of data management categories of data portions to an Access and Mobility Management Function (AMF) 706, including the indications. From the AMF 706, information may be sent to IoT devices directly from AMF or through a gNodeB based on status of the recipient IoT device, i.e. idle or connected mode. In this example, device information exchanged between NEF 704 and AMF 706 may include the indications and thus the AMF 706 does not store, log or trace data portions that are categorized as privacy sensitive for example.

As shown in FIG. 7, the IoT network 702 may send a request 708 to the NEF 704 including JSON data that includes data management categories (classifiedAttributes in this example). This data is forwarded to AMF 706 as request 710 including the data management categories. The AMF 706 replies to NEF 704 with response 712 that includes response JSON data, this response JSON data includes data management categories (classifiedProperties in this example). This data is forwarded along with the data management categories from NEF 704 to the IoT network 702 and ultimately to the recipient IoT device where appropriate.

In another example, the Service Communication Proxy (SCP) may be used for interconnecting different network functions in 5G architecture. SCP can be used between PLMN networks for communication between SMF and CHF. In a particular example, data management categories may be stored in a Unified Data Management (UDM) database (which is another example of a repository NF) for subscribers using GPSI (MSISDN). During charging connectivity either for converged charging or offline only charging, the UDM may send data management categories to a Policy Control Function (PCF) in policy control messages. In turn, the PCF may send the categories during PDU connection establishment in session and policy management messages. The SMF may use the data management categories for example in Nchf_ConvergedCharging Create, Nchf_ConvergedCharging Update, Nchf_ConvergedCharging Delete service operations. For example, the categories may be used in JSON messages.

Embodiments of this disclosure may be applied to 3rd party products and tools accessing user sensitive information. Examples of such products and tools may include tools which collect product level logs, data and traces that have user sensitive information. While collecting or analyzing data, these tools will not generally be aware of user sensitive information elements. There is therefore a possibility of misusing of user sensitive information while analyzing or storing data in a log or database. In addition, data may also be exchanged with other networks or nodes. Thus, providing indications data management categories for data portions with the data may ensure that such tools will be aware of sensitive or high privacy data, and appropriate data management actions can be taken before such data portions are stored and/or exchanged with other networks.

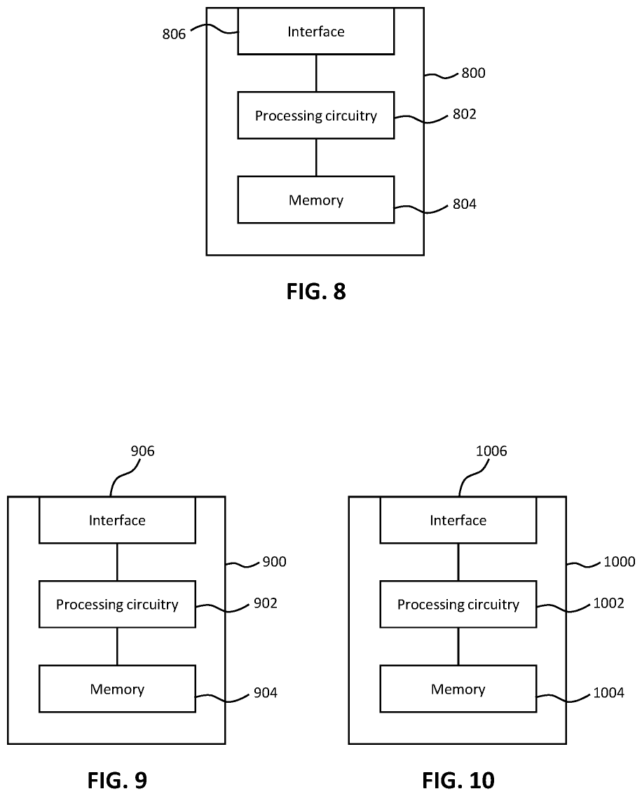

FIG. 8 is a schematic of an example of apparatus 800 for sending data to a second network function, the data comprising at least one data portion. The apparatus 800 comprises processing circuitry 802 (e.g. one or more processors) and a memory 804 in communication with the processing circuitry 802. The memory 804 contains instructions executable by the processing circuitry 802. The apparatus 800 also comprises an interface 806 in communication with the processing circuitry 802. Although the interface 806, processing circuitry 802 and memory 804 are shown connected in series, these may alternatively be interconnected in any other way, for example via a bus.

In one embodiment, the memory 804 contains instructions executable by the processing circuitry 802 such that the apparatus 800 is operable to include in the data, for each of at least one of the at least one data portion, an indication of a data management category for the data portion, and send the data to the second network funct. In some examples, the apparatus 800 is operable to carry out the method 100 described above with reference to FIG. 1.

FIG. 9 is a schematic of an example of apparatus 900 for data management by a second network function. The apparatus 900 comprises processing circuitry 902 (e.g. one or more processors) and a memory 904 in communication with the processing circuitry 902. The memory 904 contains instructions executable by the processing circuitry 902. The apparatus 900 also comprises an interface 906 in communication with the processing circuitry 902. Although the interface 906, processing circuitry 902 and memory 904 are shown connected in series, these may alternatively be interconnected in any other way, for example via a bus.

In one embodiment, the memory 904 contains instructions executable by the processing circuitry 902 such that the apparatus 900 is operable to receive data from a first network function, the data comprising at least one data portion and, for each of at least one of the at least one data portion, an indication of a data management category for the data portion, and for each data portion, perform data management in accordance with the data management category of the data portion. In some examples, the apparatus 900 is operable to carry out the method 500 described above with reference to FIG. 5.

FIG. 10 is a schematic of an example of apparatus 1000 comprising processing circuitry 1002 (e.g. one or more processors) and a memory 1004 in communication with the processing circuitry 1002. The memory 1004 contains instructions executable by the processing circuitry 1002. The apparatus 1000 also comprises an interface 1006 in communication with the processing circuitry 1002. Although the interface 1006, processing circuitry 1002 and memory 1004 are shown connected in series, these may alternatively be interconnected in any other way, for example via a bus.

In one embodiment, the memory 1004 contains instructions executable by the processing circuitry 1002 such that the apparatus 1000 is operable to receive, from a first network function, a request for a respective data management category of at least one data portion in data, and send an indication of the respective data management category of the at least one data portion to the first network function. In some examples, the apparatus 1000 is operable to carry out the method 600 described above with reference to FIG. 6.

Embodiments and methods of this disclosure may be implemented in any network function such as a 5G network function or any entity in a Service Based Architecture (SBA). In some examples, methods may be deployed container-based applications, such as for example cloud-based applications or functions, that is, for example, functions that are remote from a NF producer or NF consumer, or from a network function sending or receiving data, and accessed over a network. In particular, methods referred to herein that relate to methods in a repository function may be implemented as could-based implementations. A cloud-based implementation of any embodiment of this disclosure may be implemented in multiple parts in respective cloud-based network functions, nodes or locations.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-66. (canceled)

67. A method in a first network function of sending data to a second network function, the data comprising at least one data portion, the method comprising:
including in the data, for each of at least one of the at least one data portion, an indication of a data management category for the data portion; and
sending the data to the second network function.

68. The method of claim 67, wherein the indication of a data management category for a data portion indicates one or more data management actions for the data portion by the second network function.

69. The method of claim 68, wherein the one or more data management actions for a data portion by the second network function comprise whether or not to store the data portion.

70. The method of claim 68, wherein the one or more data management actions for a data portion by the second network function comprise whether or not to forward the data portion to a third network function, anonymize the data portion, encrypt the data portion and/or perform another operation on the data portion.

71. The method of claim 68, comprising receiving an indication of the one or more data management actions for each category from a repository network function.

72. The method of claim 71, wherein the repository network function comprises a Network Repository Function (NRF).

73. The method of claim 68, comprising sending an indication of the one or more data management actions for each category to a repository network function.

74. The method of claim 73, comprising determining one or more updated data management actions for at least one category, and sending an indication of the one or more updated data management actions to the repository network function.

75. The method of claim 67, wherein each data portion comprises one or more Information Elements (IEs).

76. The method of claim 67, wherein the data comprises a JavaScript Object Notation (JSON) data structure, and each data portion comprises one or more JSON objects, arrays, properties and/or key-value pairs.

77. The method of claim 67, wherein the data comprises a data structure defined by a data structure schema, and wherein the indication of the data management category for the data portion is not defined in the schema.

78. The method of claim 67, wherein the data management category for each data portion comprises a respective one of a plurality of categories.

79. The method of claim 78, comprising receiving an indication of the respective category of at least one data portion from a repository network function.

80. The method of claim 78, comprising sending an indication of the respective category for at least one data portion to a repository network function.

81. The method of claim 80, comprising determining one or more updated categories for at least one data portion, and sending an indication of the one or more updated categories for at least one data portion to the repository network function.

82. A method of data management in a second network function, the method comprising:
receiving data from a first network function, the data comprising at least one data portion and, for each of at least one of the at least one data portion, an indication of a data management category for the data portion; and
for each data portion, performing data management in accordance with the data management category of the data portion.

83. Apparatus for sending data to a second network function, the data comprising at least one data portion, the apparatus comprising a processor and a memory, the memory containing instructions executable by the processor such that the apparatus is operable to implement a first network function and:
include in the data, for each of at least one of the at least one data portion, an indication of a data management category for the data portion; and
send the data to the second network function.

84. Apparatus for data management by a second network function, the apparatus comprising a processor and a memory, the memory containing instructions executable by the processor such that the apparatus is operable to:
receive data from a first network function, the data comprising at least one data portion and, for each of at least one of the at least one data portion, an indication of a data management category for the data portion; and
for each data portion, perform data management in accordance with the data management category of the data portion.
